(19) United States
(12) Patent Application Publication
(10) Pub. No.: US 2005/0204399 A1
(43) Pub. Date: Sep. 15, 2005

(54) Portable terminal, digital data-distribution server, and data-sending/receiving system

(75) Inventors: Yutaka Matsunobu, Tokyo (JP); Junichi Sakamura, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/034,441

(22) Filed: Jan. 10, 2005

(30) Foreign Application Priority Data
Mar. 12, 2004 (JP) 2004-071641

(51) Int. Cl. H04N 7/173

(52) U.S. Cl. 725/117; 725/118

(57) ABSTRACT

A portable terminal includes a tuner to receive broadcast signals; a receiver to receive data communication signals from a remote server; a display to show images represented by image data from the broadcast signals or the data communication signals; a detector coupled to the tuner to detect a signal intensity of the broadcast signals; and a data processor to process the image data from the broadcast signals or the data communication signals and the send the processed image data to the display to be displayed, wherein the data processor receives and processes the image data from the broadcast signals if it is determined that the signal intensity of the broadcast signals is greater than a reference value, and receives and processes the image data from the data communication signals if it is determined that the signal intensity of the broadcast signals is less than the reference value.

### CROSS-REFERENCES TO RELATED APPLICATIONS

This application claims priority to Japanese Patent Application No. 2004-071641, filed on Mar. 12, 2004.

### BACKGROUND OF THE INVENTION

The present invention relates to a portable terminal and a data-sending/receiving system with a digital data-distribution server.

A method of complementing digital broadcasts and a system for receiving digital broadcasts are already proposed to complement data promptly and reduce the probability of interruption of audio and video output due to unexpected, sudden disruption of digital broadcast waves. According to the proposal, digital data, which may be lost partially due to instantaneous disruption of broadcast waves, are acquired in advance from the broadcasting station through communication with the broadcasting station or through broadcast waves from the broadcasting station and stored in the terminal as complementing data. If the digital data are actually partially lost, the partially lost digital data are complemented using the complementing data on the terminal's side to prevent the interruption of audio and video output at the terminal. The prediction or estimation of loss of digital data includes complete loss prediction and the estimation of probability of loss of digital data (see, for example, Japanese Unexamined Patent Publication No. 2003-298541).

According to the above proposal, a mobile terminal can receive digital broadcasts without interruption of audio or video output due to instantaneous interruption of broadcast waves.

Portable terminals (e.g., portable telephones and personal digital assistants) capable of receiving television broadcasts (hereinafter “TV broadcasts”) have recently been put to practical use. When ground-wave digital TV broadcasting for mobile terminals starts in the near future, portable terminals capable of receiving ground-wave digital TV broadcasts will be put to practical use. On the other hand, with the ever-increasing data-communication speed, the supply of contents data containing dynamic-image data to portable terminals based on data-communication technology has started.

Accordingly, real-time supply of dynamic-image data to portable terminals, namely, supply of dynamic-image data through TV broadcasting and data communication is expected in the future.

### BRIEF SUMMARY OF THE INVENTION

One feature of the present invention, therefore, is to enable a portable terminal to receive automatically (i) TV-broadcast waves while it is in an area where such waves can be received and (ii) contents-data-carrying data-communication waves while it is in an area where such waves can be received.

Another feature of the present invention is to hold down communication expenses which the user of a portable terminal has to pay for data he received in a data-sending/receiving system.

A portable terminal in accordance with the first viewpoint of the present invention is capable of receiving TV-broadcast waves and digital-data-carrying data-communication waves and comprises (i) a display to show images represented by inputted image data, (ii) a detector to find whether the intensity of received TV-broadcast waves is over a prescribed reference value or not, and (iii) a data processor to perform prescribed data processing selectively on either image data extracted from received TV-broadcast waves or image data contained in digital data carried by received data-communication waves and send the processed image data to the display. If the detector finds the intensity of received TV-broadcast waves to be over a predefined reference value, the data processor performs predefined data processing on image data extracted from the received TV broadcast waves and sends the processed image data to the display. If the detector finds the intensity of received TV-broadcast waves to be below the predefined reference value, the data processor performs predefined data processing on image data contained in digital data carried by received data-communication waves and sends the processed image data to the display.

In a preferred embodiment according to the first viewpoint of the present invention, the above portable terminal comprises further (i) a checker to check the data rate of the above digital data being transmitted to the portable terminal by radio communication and (ii) a transmitter to transmit the checked result to a digital data-distribution server which is the source of the digital data.

In another embodiment according to the first viewpoint of the present invention, a base station, which transmits the above digital data to the above portable terminal, (i) has data on the number of portable terminals in its coverage, (ii) infers the above data rate from the data on the number of portable terminals, and (iii) informs the above portable terminal of the inferred data rate.

In still another embodiment according to the first viewpoint of the present invention, the above data processor chooses either image data extracted from received TV-broadcast waves or image data contained in digital data carried by received data-communication waves in accordance with predefined priorities.

In a further embodiment according to the first viewpoint of the present invention, the above priorities are determined based on factors including communication charge to the user of the above portable terminal and the stability of radio waves received by the portable terminal.

In a still further embodiment according to the first viewpoint of the present invention, the above portable terminal further comprises a memory to store temporarily image data extracted from received TV broadcast waves or image data contained in digital data carried by received data-communication waves and output the stored image data in response to a demand from the above data processor.

A digital data-distribution server in accordance with the second viewpoint of the present invention distributes digital data to portable terminals and comprises (i) an input unit which the above checked result of the data rate is inputted into, (ii) a communication quality-determining unit to determine, based on the checked result of the data rate, in what quality the above digital data should be sent to the above portable terminal, and (iii) a digital-data transmitter to transmit the digital data to the portable terminal in the determined communication quality.

In a preferred embodiment according to the second viewpoint of the present invention, the above communication quality-determining unit determines whether to perform high-quality wideband data communication or low-quality narrow-band data communication.

In another embodiment according to the second viewpoint of the present invention, the above digital data-distribution server further comprises a charging unit to charge the user of the above portable terminal a charge for digital data.

A data-sending/receiving system in accordance with the third viewpoint of the present invention comprises (i) a portable terminal capable of receiving TV-broadcast waves and digital-data-carrying data-communication waves and (ii) a digital data-distribution server to distribute digital data to the portable terminal. The portable terminal comprises (i) a display to show images represented by inputted image data, (ii) a detector to find whether or not the intensity of received TV-broadcast waves is over a reference value, and (iii) a data processor to perform predefined data processing selectively on either image data extracted from received TV-broadcast waves or image data contained in digital data carried by received data-communication waves and send the processed image data to the display. If the detector finds the intensity of received TV-broadcast waves to be over a predefined reference value, the data processor performs predefined data processing on image data extracted from the received TV broadcast waves and sends the processed image data to the display. If the detector finds the intensity of received TV-broadcast waves to be below the reference value, the data processor performs prescribed data processing on image data contained in digital data carried by received data-communication waves and sends the processed image data to the display. The digital data-distribution server comprises (i) an input unit which the above checked result of the data rate is inputted into, (ii) a communication quality-determining unit to determine, based on the checked result of the data rate, in what quality the above digital data should be sent to the above portable terminal, and (iii) a digital-data transmitter to transmit the digital data to the portable terminal in the determined communication quality.

According to the present embodiments, it is possible for a portable terminal to receive automatically TV-broadcast waves while it is in an area where such waves can be received and contents-data-carrying data-communication waves while it is in an area where such waves can be received.

According to the present embodiments, communication expenses which the user of a portable terminal has to pay for data he received in a data-sending/receiving system can be kept down.

In one embodiment, a portable terminal includes a tuner to receive broadcast signals; a receiver to receive data communication signals from a remote server; a display to show images represented by image data from the broadcast signals or the data communication signals; a detector coupled to the tuner to detect a signal intensity of the broadcast signals; and a data processor to process the image data from the broadcast signals or the data communication signals and the send the processed image data to the display to be displayed, wherein the data processor receives and processes the image data from the broadcast signals if it is determined that the signal intensity of the broadcast signals is greater than a reference value, and receives and processes the image data from the data communication signals if it is determined that the signal intensity of the broadcast signals is less than the reference value.

The portable terminal further includes a module to sample the data communication signals received by the receiver of the portable terminal. The sampled signals are used to determine a data rate of the data communication signals. A transmitter transmits a control signal to the remote server, the control sign being generated in response to the data rate that has been determined. The module includes the detector in one implementation. The module includes a controller coupled to the detector and is configured to determine the data rate in another implementation.

In another embodiment, a digital data-distribution server for distributing digital data to a portable terminal includes an input unit to receive data rate transmission information on a portable terminal, the data rate transmission information providing information on a data rate at which data can be to transferred to the portable terminal; a communication quality-determining unit to determine a data rate at which data is to be transmitted to the portable terminal based on the data rate transmission information received by the input unit; and a digital-data transmitter to transmit digital data to the portable terminal according to the data rate determined by the communication quality-determining unit.

In yet another embodiment, a method for operating a portable terminal includes detecting a signal intensity of broadcast signals received by the portable terminal; receiving the broadcast signals from a first remote server; displaying the received broadcast signals as an image on a display of the portable terminal if the signal intensity is greater than a given value; receiving data communication signals from a second remote server; and displaying the received data communication signals as an image on the display of the portable terminal if the signal intensity of the broadcast signals is not greater than the given value.

### BRIEF DESCRIPTION OF THE DRAWINGS

FIG. 1 is an illustration of the general formation of a data-sending/receiving system in accordance with an embodiment of the present invention;

FIG. 1A illustrates a contents-distribution server according to one embodiment of the present invention;

FIG. 2 is a flowchart of processing by the portable terminal 9 of FIG. 1 receiving TV-broadcast waves or digital-data-carrying data-communication waves;

FIGS. 3 and 4 are illustrations of the processing of the contents-distribution server of FIG. 1 when the portable terminal of FIG. 1 has moved from a non-quality-distribution/reception area into a quality-distribution/reception area;

FIG. 5 is a flowchart of the processing by the portable terminal of FIG. 1 and the processing of quality change by the contents-distribution server of FIG. 1 when the portable terminal has detected itself moving from a non-quality-distribution/reception area into a quality-distribution/reception area;

FIG. 6 is a block diagram of the portable terminal of FIG. 1;

FIG. 7 is a chart showing the relationship between time and the reception sensitivity of image data carried by TV-broadcast waves received by the portable terminal of FIG. 6;

FIG. 8 is a chart showing the relationship between time and the reception sensitivity of image data carried by TV-broadcast waves received by the portable terminal of FIG. 6 and the relationship between time and the reception sensitivity of image data carried by data-communication waves received by the portable terminal of FIG. 6;

FIG. 9 is a flowchart of the processing by the controller of the portable terminal of FIG. 6 and the processing of quality change by the contents-distribution server of FIG. 1;

FIG. 10 is another block diagram of the portable terminal of FIG. 1; and

FIG. 11 is a chart showing the relationship between time and the reception sensitivity of image data carried by TV-broadcast waves received by the portable terminal of FIG. 10 and the relationship between time and the reception sensitivity of image data carried by data-communication waves received by the portable terminal of FIG. 10.

### DETAILED DESCRIPTION OF THE INVENTION

Referring to the drawings, preferred embodiments of the present invention will be detailed below.

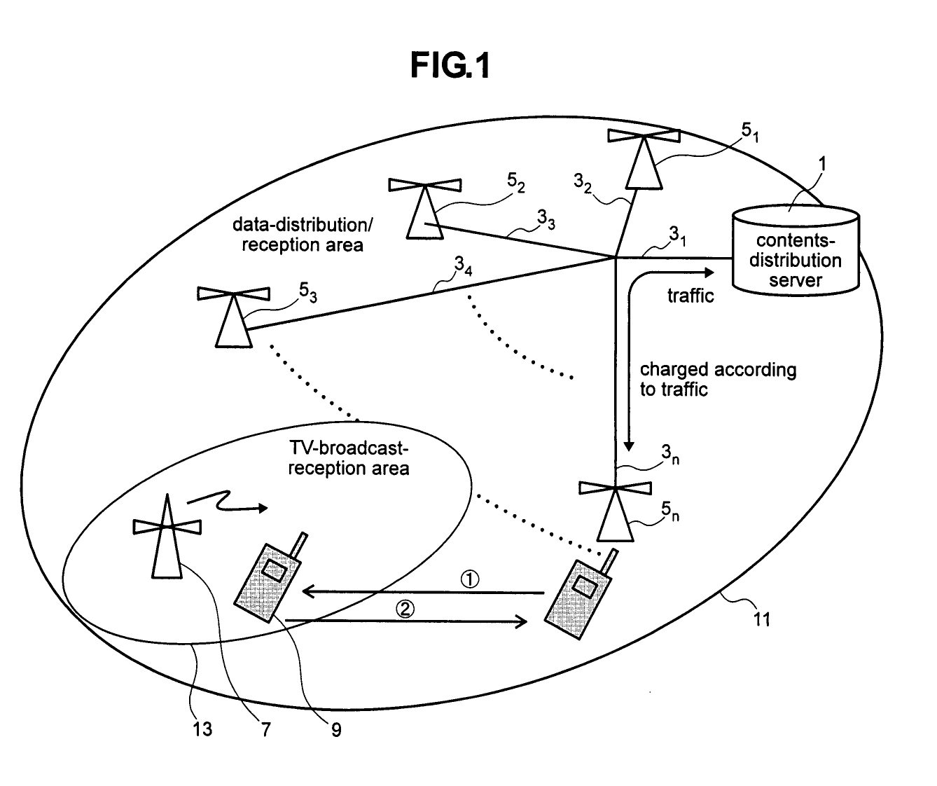

FIG. 1 is an illustration of the general formation of a data-sending/receiving system in accordance with an embodiment of the present invention.

As shown in FIG. 1, the data-sending/receiving system comprises a contents-distribution server 1, a plurality of data-transmission lines 3₁ to 3ₙ, a plurality of data-sending/receiving base stations 5₁ to 5ₙ, a base station for television broadcasting (hereinafter “TV-broadcasting base station”) 7, and a portable terminal 9. The contents-distribution server 1 is connected to the data-sending/receiving base stations 5₁ to 5ₙ by the data-transmission lines 3₁ to 3ₙ. The contents-distribution server 1, data-transmission lines 3₁ to 3ₙ, data-sending/receiving base stations 5₁ to 5ₙ, and the TV-broadcasting base station 7 are located in a data-distribution/reception area 11. The TV-broadcasting base station 7 is located in a TV-broadcast-reception area 13 within the data-distribution/reception area 11. The contents-distribution server 1, data-transmission lines 3₁ to 3ₙ, data-sending/receiving base stations 5₁ to 5ₙ, and the portable terminal 9 form the data-sending/receiving system. Although two or more TV-broadcasting base stations are located in the data-distribution/reception area 11, only one TV-broadcasting base station 7 is shown for the sake of simplicity. Although two or more portable terminals 9 are located in the data-distribution/reception area 11, only one portable terminal 9 is shown for the sake of simplicity.

The contents-distribution server 1 stores various digital data (for example, dynamic-image data and audio data) in its database (not shown) to supply them to the user of the portable terminal 9. When the contents-distribution server 1 receives a demand for contents data from the portable terminal 9 through the data-sending/receiving base stations 5₁ to 5ₙ and data-transmission lines 3₁ to 3ₙ, it reads the contents data from the database (not shown) and sends the contents data through the data-transmission lines 3₁ to 3ₙ and data-sending/receiving base stations 5₁ to 5ₙ to the portable terminal 9. The contents-distribution server 1 has accounting/charging data (unit prices of contents data stored in the database) and charges the user of the portable terminal 9 a charge for supplied contents data periodically on the basis of the accounting/charging data.

The data-sending/receiving base stations 5₁ to 5ₙ receive contents data (digital data) from the contents-distribution server 1 through the data-transmission lines 3₁ to 3ₙ and transmit the contents data (digital data) to the portable terminal 9 in the data-distribution/ reception area 11. The data-sending/receiving base stations 5₁ to 5ₙ receive a request for contents data from the portable terminal 9 in the data-distribution/reception area 11 and forward the request to the contents-distribution server 1 through the data-transmission lines 3₁ to 3ₙ.

The TV-broadcasting base station 7 relays broadcast waves from a TV-broadcasting station (not shown) to the portable terminal 9 in the TV-broadcast-reception area 13.

The portable terminal 9 has, in addition to the function of talking as a portable telephone, the function of communicating with the contents-distribution server 1 through the data-sending/receiving base stations 5₁ to 5ₙ and the data-transmission lines 3₁ to 3ₙ and receiving various contents data from the contents-distribution server 1 through the data-transmission lines 3₁ to 3ₙ and the data-sending/receiving base stations 5₁ to 5ₙ. The portable terminal 9 has, in addition to the above function, the function of receiving broadcast waves from the TV-broadcasting station (not shown) through the TV-broadcasting base station 7. The portable terminal 9 checks the intensity of TV-broadcast waves at appropriate time intervals to determine whether or not it is within the TV-broadcast-reception area 13. If the portable terminal 9 is within the TV-broadcast-reception area 13 and receiving contents data from the contents-distribution server 1, the portable terminal 9 stops receiving contents data carried by data-communication waves and starts receiving TV-broadcast waves. If the portable terminal 9 is outside the TV-broadcast-reception area 13 and receiving TV-broadcast waves, the portable terminal 9 stops receiving the TV-broadcast waves and starts receiving contents data carried by data-communication waves.

FIG. 1A illustrates a contents-distribution server 1′ corresponding to that shown in FIG. 1. The server communicates with the portable terminal 9 via one or more relay devices/base stations 5n. The server includes an input unit to receive data from the base station, a communication quality determining unit to determine the quality of communication to be provided to the portable terminal, a digital-data transmitter 16 to transmit data to the portable terminal, and a charging unit to determine the amount of fee to be charged to the user of the portable terminal. The fee charged to the user depends on the quality of communication provided to the portable terminal, as explained in more details below.

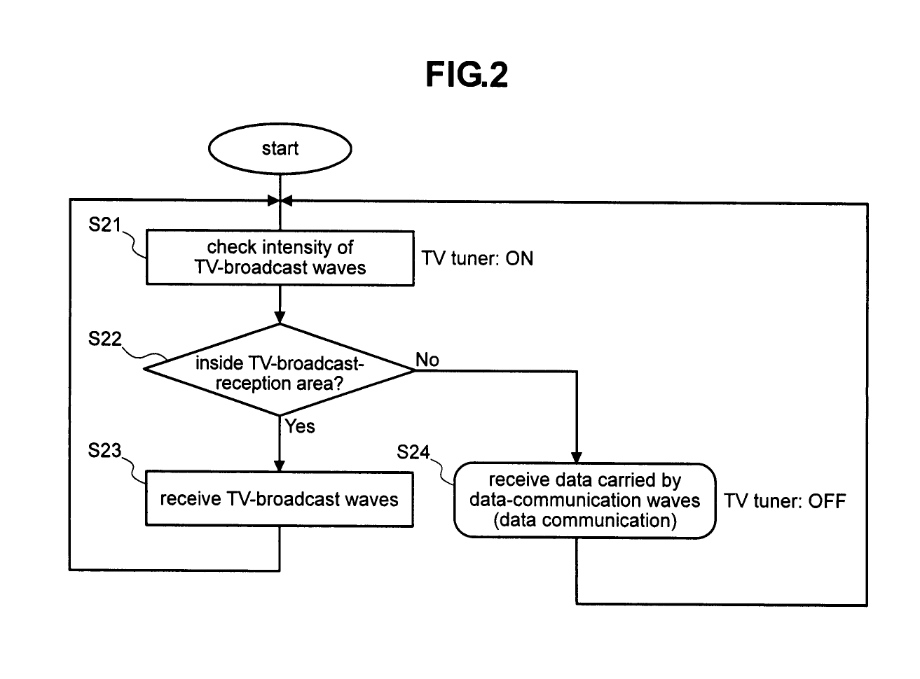

FIG. 2 is a flowchart of processing by the portable terminal 9 of FIG. 1 receiving TV-broadcast waves or digital data (contents) carried by data-communication waves.

In FIG. 2, the portable terminal 9 checks the intensity of TV-broadcast waves at appropriate time intervals (regular time intervals or any time intervals) while it is receiving TV-broadcast waves (Step S21). If the intensity of TV-broadcast waves is greater than a predefined value (or threshold value), the portable terminal 9 judges itself to be within the TV-broadcast-reception area 13 (Step S22), continues to receive TV-broadcast waves (Step S23), and returns to Step S21.

If the intensity of TV-broadcast waves is less than the predefined value, the portable terminal 9 judges itself to be outside the TV-broadcast-reception area 13 (Step S22), stops receiving TV-broadcast waves, starts receiving contents data carried by data-communication waves (Step S24), and returns to Step S21.

Thus, when the user of the portable terminal 9 of FIG. 1 enters the TV-broadcast-reception area 13, the portable terminal 9 stops receiving chargeable contents data carried by data-communication waves and starts receiving TV-broadcast waves which are generally free of charge; therefore, the user can save money. When the user moves out of the TV-broadcast-reception area 13 into the data-distribution/reception area 11, the portable terminal 9 stops receiving the TV-broadcast waves and starts receiving the contents data carried by data-communication waves; therefore, the user can receive TV-broadcast waves and contents data carried by data-communication waves continuously without interruption.

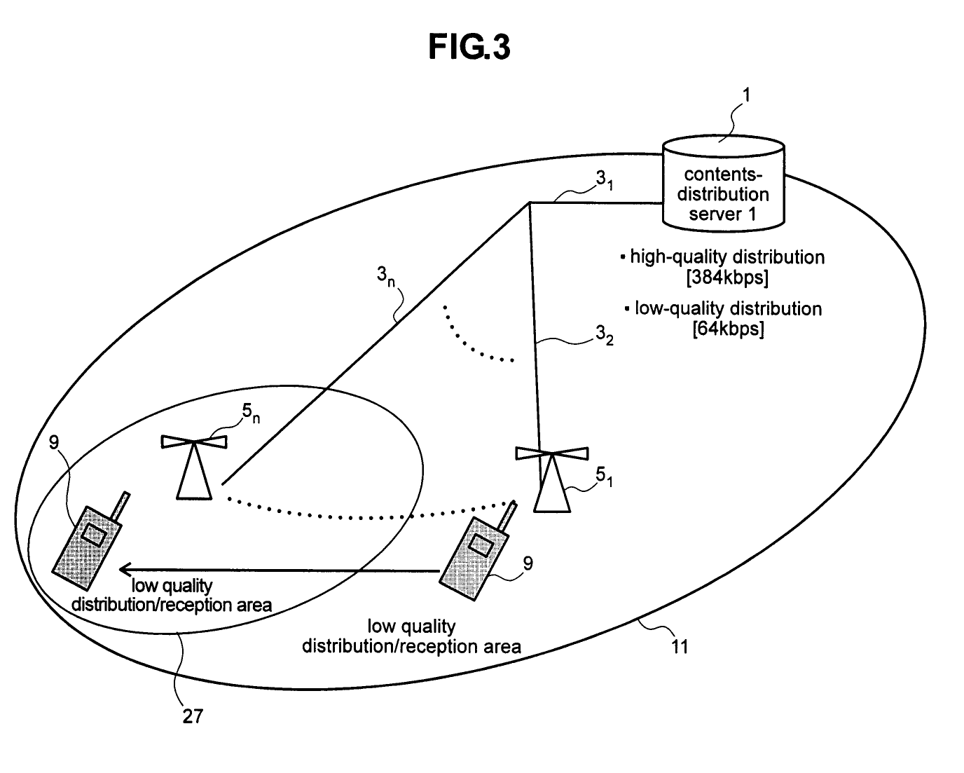

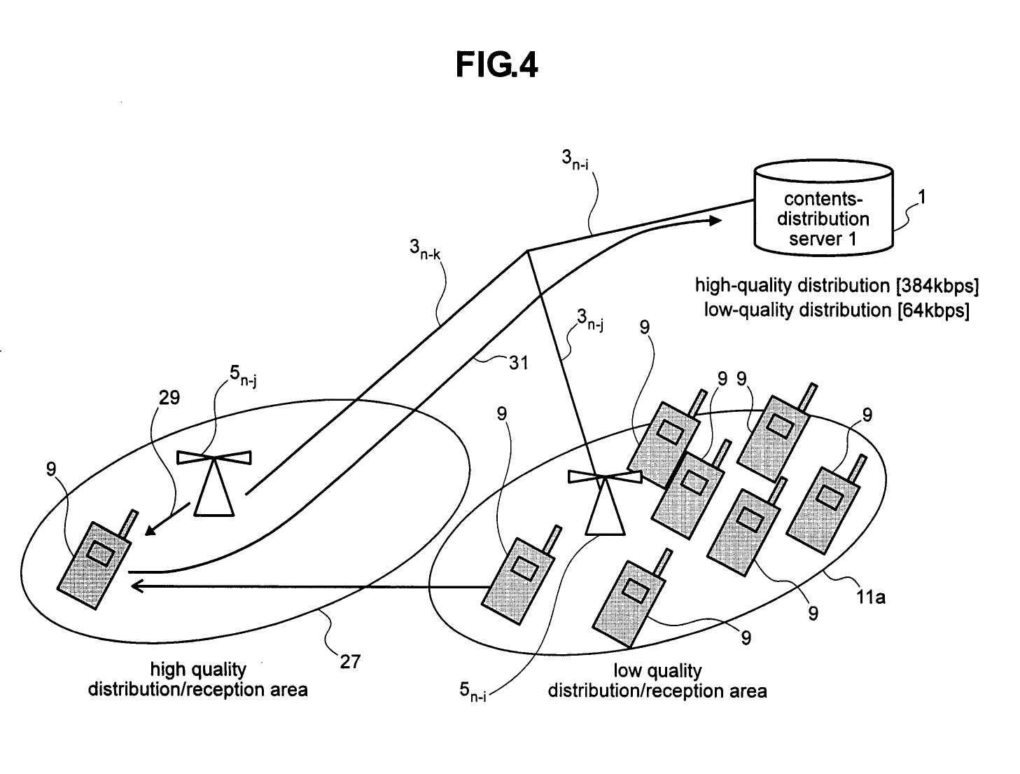

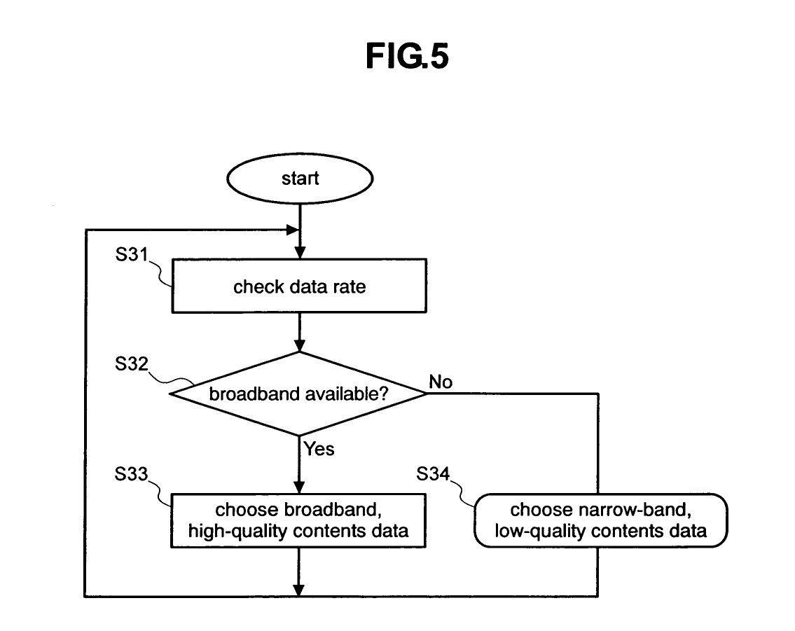

FIGS. 3 and 4 are illustrations of the processing of the contents-distribution server 1 when the portable terminal 9 has moved from a non-quality-distribution/reception area (wherein contents data distributed in high quality cannot be received) into a quality-distribution/reception area (wherein contents data distributed in high quality can be received).

In FIGS. 3 and 4, the contents-distribution server 1 transmits user-demanded contents data in low quality of, for example, 64 kbps to a portable terminal 9 in a non-quality-distribution/reception area (or data-distribution/reception area) through the data-transmission lines 3₁ to 3ₙ and the data-sending/receiving base stations 5₁ to 5ₙ. At the same time, the contents-distribution server 1 transmits user-demanded contents data in high quality of, for example, 384 kbps (namely, higher-quality wideband data communication) to a portable terminal 9 in a quality-distribution/reception area 27 through the data-transmission lines 3₁ to 3ₙ and the data-sending/receiving base stations 5₁ to 5ₙ.

In FIG. 4, a data-sending/receiving base station 5ₙ₋ᵢ is capable of determining the number of portable terminals 9 within its coverage (or non-quality-distribution/reception area 11a). Similarly, a data-sending/receiving base station 5ₙ₋ⱼ is capable of determining the number of portable terminals 9 within its coverage (or quality-distribution/reception area 27).

The data-sending/receiving base station 5ₙ₋ⱼ, for example, informs the portable terminals 9 in the quality-distribution/reception area 27 of a data rate inferred from the number of portable terminals 9 as shown by the reference numeral 29. Then, a portable terminal 9 in the quality-distribution/reception area 27 informs the contents-distribution server 1 of the data rate as shown by the reference numeral 31. In other words, the portable terminal 9 requires the contents-distribution server 1 to choose contents data of the highest possible quality grade among contents data of different quality grades prepared in advance and transmit the chosen contents data.

The portable terminal 9 checks the data rate approximately by checking the intensity, E_{c}/Iₒ, etc. of data-communication waves from the data-sending/receiving base stations 5₁ to 5ₙ.

FIG. 5 is a flowchart of the processing by the portable terminal 9 and the processing of quality change by the contents-distribution server 1 when a portable terminal has detected itself moving from a non-quality-distribution/reception area 11 into a quality-distribution/ reception area 27.

In FIG. 5, first, the portable terminal 9 determines the data rate as described above and sends the determined result to the contents-distribution server 1 (Step S31). The contents-distribution server 1 decides based on the data rate whether or not to secure a wideband, namely, whether or not to transmit user-demanded contents data in high quality of 384 kbps or so (Step S32). If the contents-distribution server 1 decides that a wideband should be secured (Step S32), the contents-distribution server 1 chooses wideband, high-quality contents data from the contents data of different quality grades in its database (not shown) and sends the chosen contents data to the portable terminal 9 (Step S33).

If the contents-distribution server 1 decides not to secure a wideband (Step S32), it chooses narrow band, low-quality contents data from the contents data of different quality grades in its database (not shown) and sends the chosen contents data to the portable terminal 9 (Step S34).

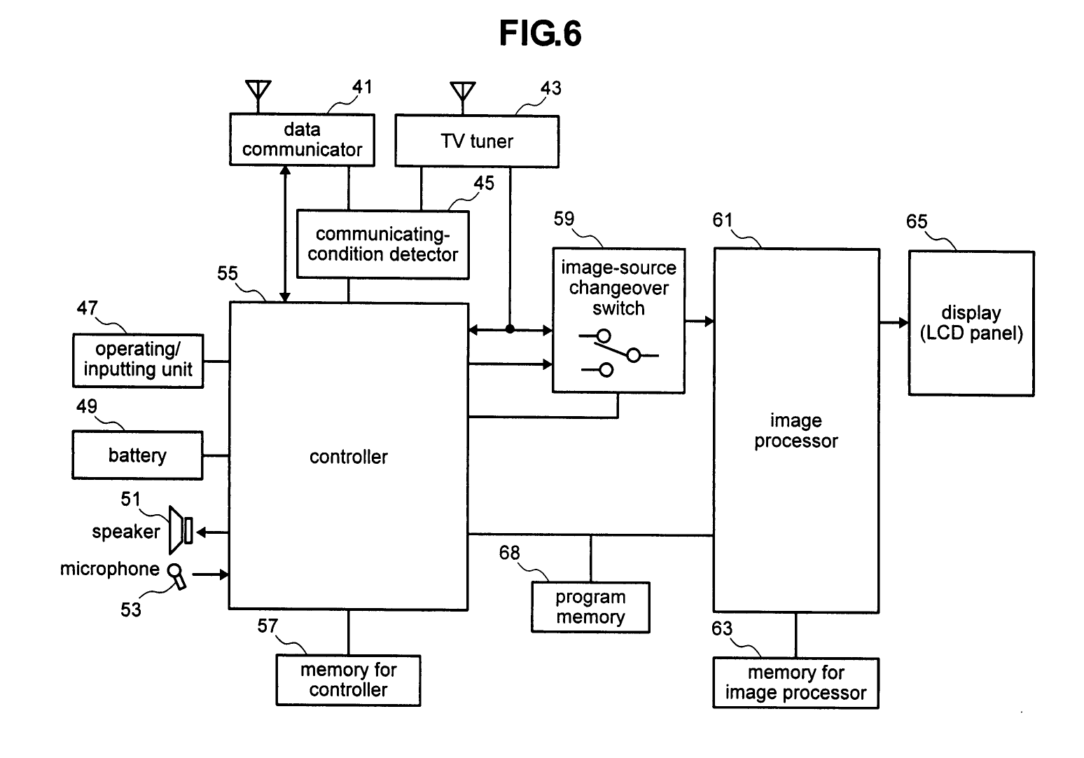

FIG. 6 is a block diagram of the portable terminal 9.

As shown in FIG. 6, the portable terminal 9 comprises a radio communicator 41, a TV receiver 43, a communicating-condition detector 45, an operating/inputting unit 47, a battery 49, a speaker 51, a microphone (mike) 53, a controller 55, a memory 57 for the controller 55, an image-source changeover switch 59, an image processor 61, a memory 63 for the image processor 61, and a display (LCD panel) 65.

The radio communicator 41, under the control of the controller 55, performs radio communication relating to data communication service such as the transmission of demands for contents data to the contents-distribution server 1 and the reception of contents data from the contents-distribution server 1. The radio communicator 41, when used as a telephone, performs audio or voice communication with other portable terminals. These two types of radio communication are conducted selectively.

The TV receiver 43 receives TV-broadcast waves transmitted by a TV-broadcasting station (not shown) and relayed by, for example, the TV-broadcasting base station 7 of FIG. 1, demodulates the received TV-broadcast waves, and sends image data (graphic data) to the image-source changeover switch 59 and audio data to the controller 55.

The communicating-condition detector 45, under the control by the controller 55, detects the intensity of contents-data-carrying data-communication waves received by the radio communicator 41 and the intensity of TV-broadcast waves received by the TV receiver 43 and expresses the intensities as indexes. Besides, under the control of the controller 55, the communicating-condition detector 45 calculates the quantity of contents data per unit time received by the radio communicator 41 and the quantity of television data per unit time received by the TV receiver 43 and expresses the quantities as indexes. Moreover, under the control by the controller 55, the communicating-condition detector 45 detects, as an index, the number of times of correction of errors in data communication which the radio communicator 41 makes with the contents-distribution server 1 through data-sending/receiving base stations 5₁ to 5ₙ.

The communicating-condition detector 45 outputs the results of the above detection to the controller 55.

Under the control of the controller 55, the image-source changeover switch 59 changes the source of image data to be outputted to the image processor 61 from the TV receiver 43 to the radio communicator 41. Besides, under the control of the controller 55, the image-source changeover switch 59 changes the source of image data to be outputted to the image processor 61 from the radio communicator 41 to the TV receiver 43. Accordingly, either image data outputted by the TV receiver 43 or image data outputted by the radio communicator 41 through the controller 55 are selectively outputted from the image-source changeover switch 59 to the image processor 61.

Under the control of the controller 55, the image processor 61 performs necessary data processing (image processing) on the image data from the image-source changeover switch 59 and outputs the processed image data to the display 65.

Stored in the memory 63 for the image processor 61 are data necessary for the image processor 61 to perform the above data processing (image processing), data after the data processing, and so on.

Arranged on the operating/inputting unit 47 are various keys (not shown) necessary for the user to give various instructions to the controller 55. The user operates these keys (not shown) to output prescribed voltage signals as user's instructions (commands) from the operating/inputting unit 47 to the controller 55.

The battery 49 supplies driving voltage to the controller 55 and other units (radio communicator 41, TV receiver 43, communicating-condition detector 45, memory 57 for the controller 55, image-source changeover switch 59, image processor 61, memory 63 for the image processor 61, display 65, and so on).

The speaker 51 outputs either audio data through the controller 55 from the radio communicator 41 or audio data through the controller 55 from the TV receiver 43 selectively as sound.

When the user of the portable terminal 9 talks with the user of another portable terminal (not shown), his voice is inputted into the microphone 53. The voice inputted into the microphone 53 is outputted through the controller 55 to the radio communicator 41. The voice is emitted as radio waves from the radio communicator 41 and sent to the other portable terminal (not shown) through a certain line of contact (its detailed illustration and explanation are omitted here).

Stored in the memory 57 for the controller 55 are data necessary for the controller 55 to control the above units, data after the control, and so on.

The controller 55 controls the radio communicator 41, TV receiver 43, communicating-condition detector 45, memory 57 for the controller 55, image-source changeover switch 59, image processor 61, and display 65 based on various instructions inputted through the operating/inputting unit 47 by the user. The controller 55 determines, based on the above indexes outputted by the communicating-condition detector 45, which is outputting stabler image data, the radio communicator 41 or the TV receiver 43. Then, the controller 55 controls the image-source changeover switch 59 to cause the stabler image data to be outputted to the image processor 61. The controller 55 determines which is outputting stabler image data, the radio communicator 41 or the TV receiver 43, by using pre-defined priorities about communication costs, stability of received radio waves, and so on. Namely, based on the pre-determined priorities, the image data which is determined to have higher priority is chosen.

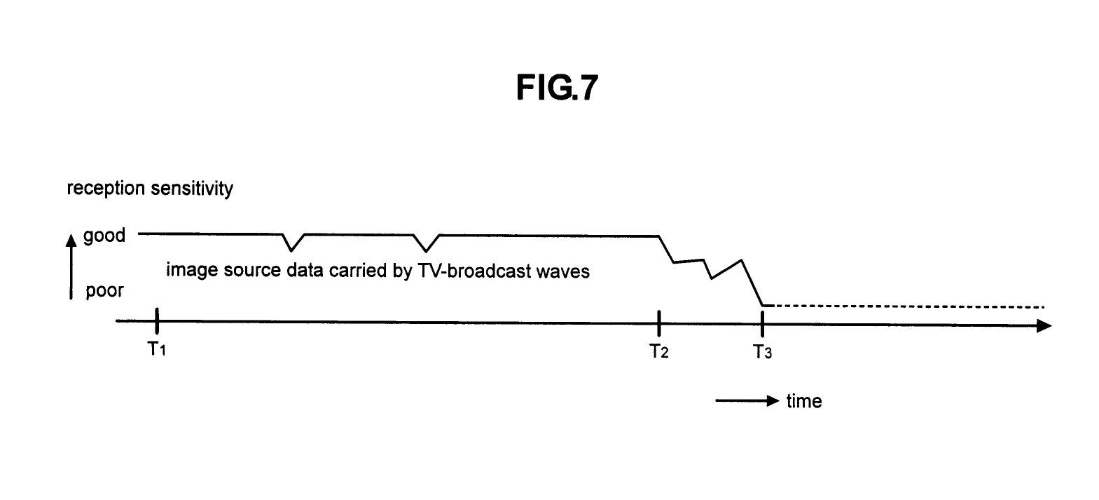

FIG. 7 is a chart showing the relationship between time and the reception sensitivity of image data carried by TV-broadcast waves received by the portable terminal 9 of FIG. 6.

In FIG. 7, between time T₁ and time T₂, the reception sensitivity of the image data carried by TV-broadcast waves is generally favorable. It is understood that this is because the portable terminal 9 is, for example, in the TV-broadcast-reception area 13 shown in FIG. 1. However, after time T₂, the above reception sensitivity decreases generally step by step. After time T₃, it is observed that the reception sensitivity is in a degraded state. It is understood that this is because the portable terminal 9 has moved between time T₂ and time T₃, for example, from the TV-broadcast-reception area 13 to the data-distribution/reception area 11 shown in FIG. 1.

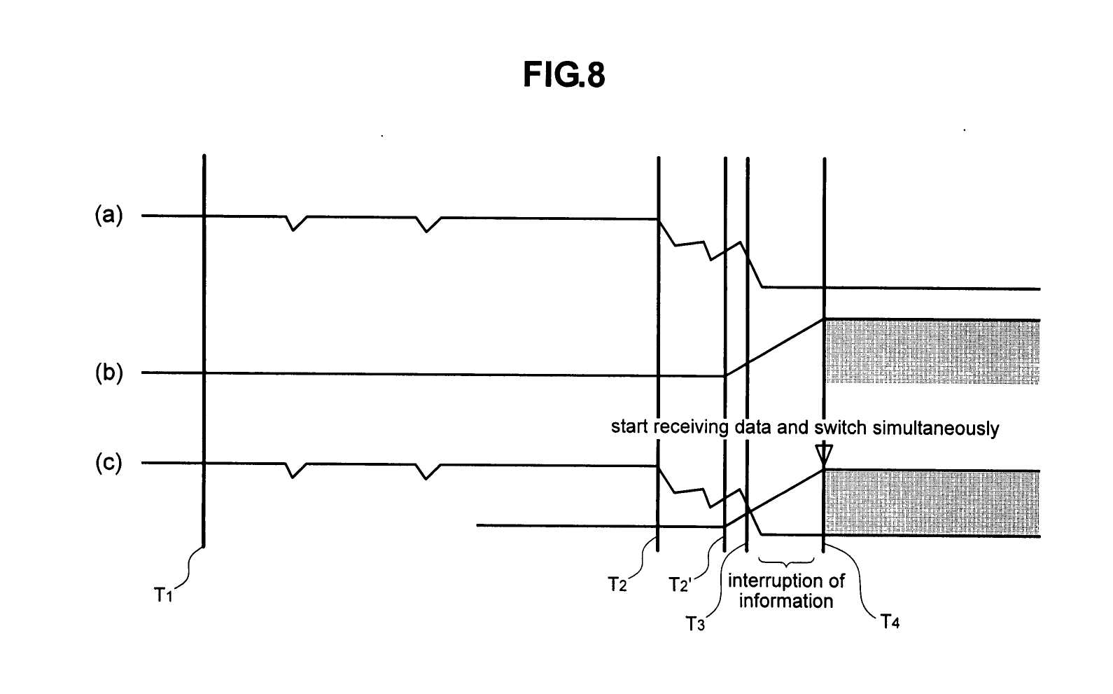

FIG. 8 is a chart showing the relationship between time and the reception sensitivity of image data carried by TV-broadcast waves received by the portable terminal 9 of FIG. 6 and the relationship between time and the reception sensitivity of image data carried by data-communication waves received by the portable terminal 9 of FIG. 6.

FIG. 8(a) shows the relationship between time and the reception sensitivity of image data carried by TV-broadcast waves received by the portable terminal 9 as described in FIG. 7. Also, FIG. 8(b) shows the relationship between time and the reception sensitivity of image data carried by data-communication waves received by the portable terminal 9 of FIG. 6. In FIG. 8(b), from time T₂′ between time T₂ and time T₃ to time T₄ after time T₃, the reception sensitivity of the image data carried by data-communication waves increases generally linearly. After time T₄, the above reception sensitivity is generally stable (in a favorable state). It is understood that this is because the portable terminal 9 starts moving from the TV-broadcast-reception area 13 to the data-distribution/reception area 11 at time T₂′ and enters the data-distribution/reception area 11 at time T₄.

FIG. 8(c) shows both the relationship between time and the reception sensitivity of image data carried by TV-broadcast waves and relationship between time and reception sensitivity of image data carried by data-communication waves when the portable terminal 9 of FIG. 6 stops receiving the former data and starts receiving the latter data. In FIG. 8(c), after the degrading of the sensitivity of the image data carried by TV-broadcast waves at time T₃, and when the image data is changed to the one carried by data-communication waves at time T4 where the sensitivity of image data carried by data-communication waves becomes generally stable (in a favorable state), neither of the image data is provided to users from the portable terminal 9 between time T₃ and time T₄.

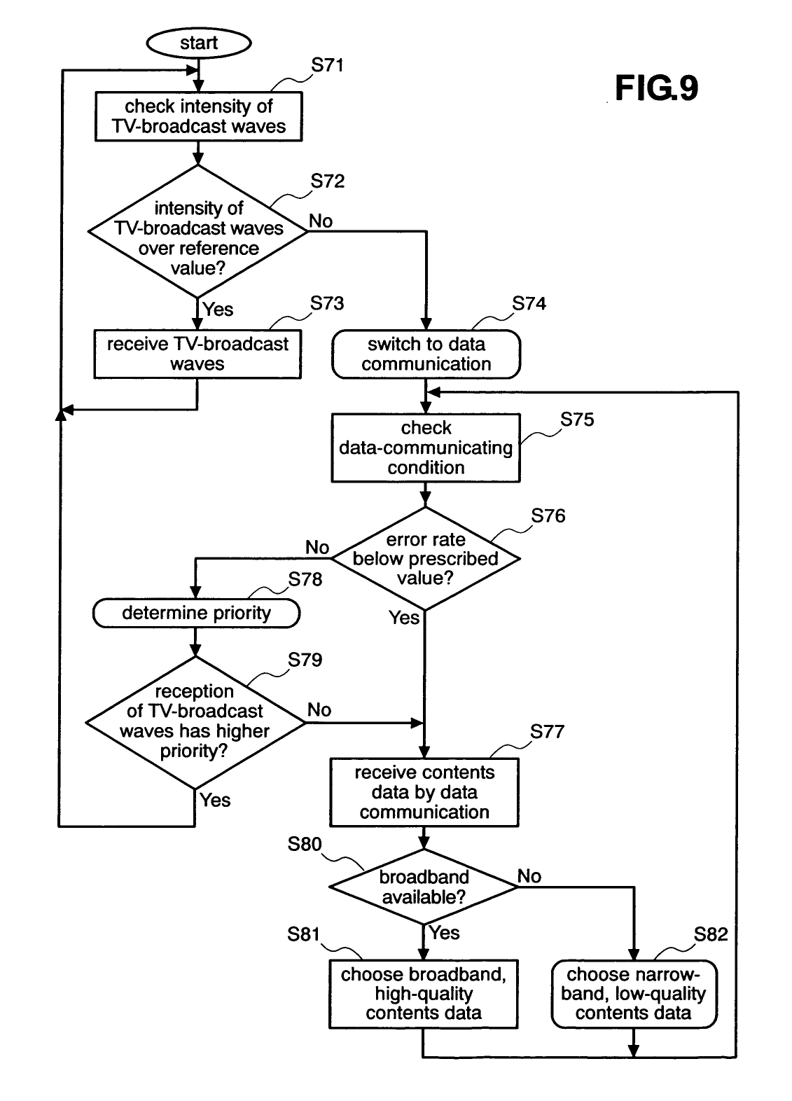

FIG. 9 is a flowchart of the processing by the controller 55 of the portable terminal 9 of FIG. 6 and the processing of quality change by the contents-distribution server 1 shown in FIG. 1 (FIGS. 3 and 4).

In FIG. 9, first, the communicating-condition detector 45 (shown in FIG. 6) of the portable terminal 9 checks the intensity of TV-broadcast waves that the portable terminal 9 is receiving (Step S71), and determines whether or not the intensity of TV-broadcast waves is greater than a given value (Step S72). If it is determined here that the intensity of TV-broadcast waves is greater than the given value (Step S72), the portable terminal 9 continues receiving TV-broadcast waves (Step S73). On the other hand, if it is determined that the intensity is below the prescribed value (Step S72), the portable terminal 9 stops receiving the TV-broadcast waves and starts receiving the contents data carried by data-communication waves (Step S74), and the communicating-condition detector 45 checks the condition of the data communication (Step S75).

Then, the communicating-condition detector 45 checks an error rate in data communication. If it is determined in the check that the error rate is less than a given value (Step S76), the portable terminal 9 starts receiving contents data carried by data-communication waves (Step S77). However, if it is determined in the above checking steps that the error rate is greater than the given value (Step S76), the procedural step advances to the previously described priority determination process of image data (Step S78). Then, it is determined whether or not the reception of TV-broadcast waves has higher priority (Step S79). If it is determined that the reception of TV-broadcast waves has higher priority according to the check (Step S79), the procedural step returns to the process in Step S71.

On the other hand, if it is determined that the reception of TV-broadcast waves has lower priority (Step S79), the procedural step advances to the process shown in Step S77. When receiving contents data carried by data-communication waves, the portable terminal 9 informs the contents-distribution server 1 of the error rate in data communication. Upon receipt of the error rate, the contents-distribution server 1 checks to see whether or not the above-described (in Step S32 of FIG. 5) wideband should be secured (Step S80). Based on the check, if the contents-distribution server 1 determines that the wideband should be secured (Step S80), the contents-distribution server 1 chooses wideband, high-quality contents data, sends the chosen contents data to the portable terminal 9 (Step S81), and instructs the portable terminal 9 to return to the process shown in Step S75. If the contents-distribution server 1 determines that the wideband should not be secured (Step S80), it chooses narrow band, low-quality contents data, sends the chosen contents data to the portable terminal 9 (Step S82), and instructs the portable terminal 9 to return to the process shown in Step S75.

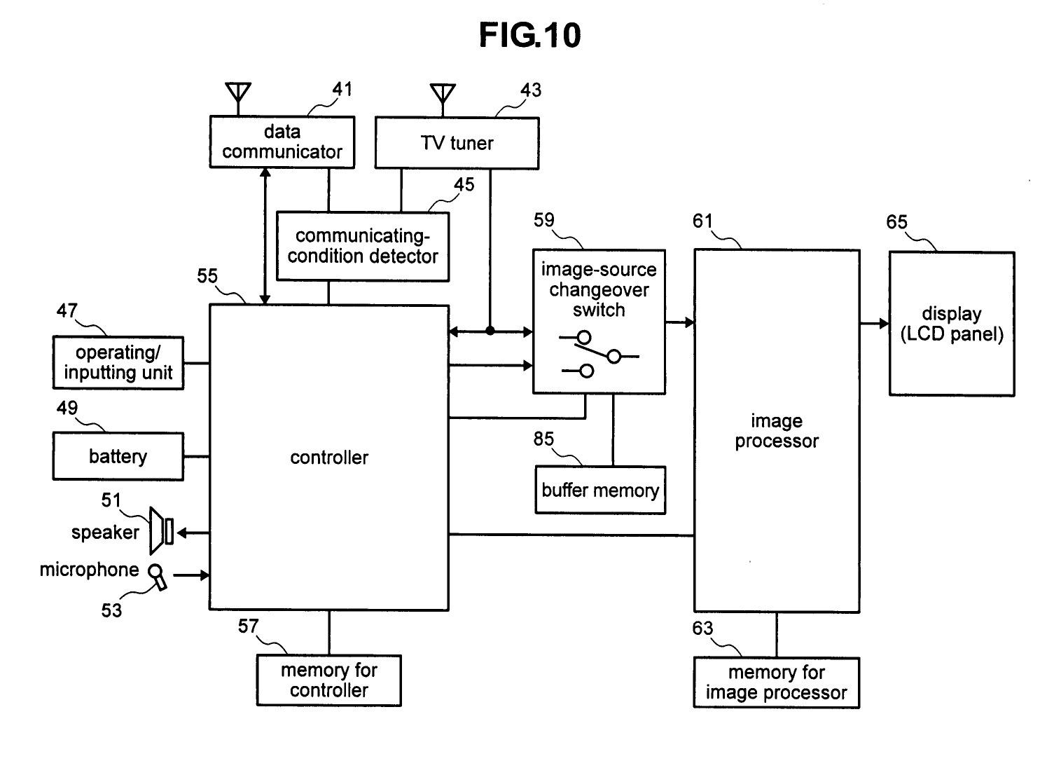

FIG. 10 is another block diagram of the portable terminal of FIG. 1. The construction of the portable terminal 9′ according to this modification is different from that of the mobile terminal 9 of FIG. 6 in that the image-source changeover switch 59 includes a buffer memory 85. The rest of the construction is the same as what is shown in FIG. 6. Therefore, in FIG. 10, like reference characters are given to like parts in FIG. 6 and detailed description thereof will be omitted.

As described above, the image-source changeover switch 59 comprises the buffer memory 85 so that image data before the changeover of the image source by the image-source changeover switch 59 is stored in the buffer memory 85. Accordingly, interruption of images shown on the display 65 caused by the changeover can be prevented.

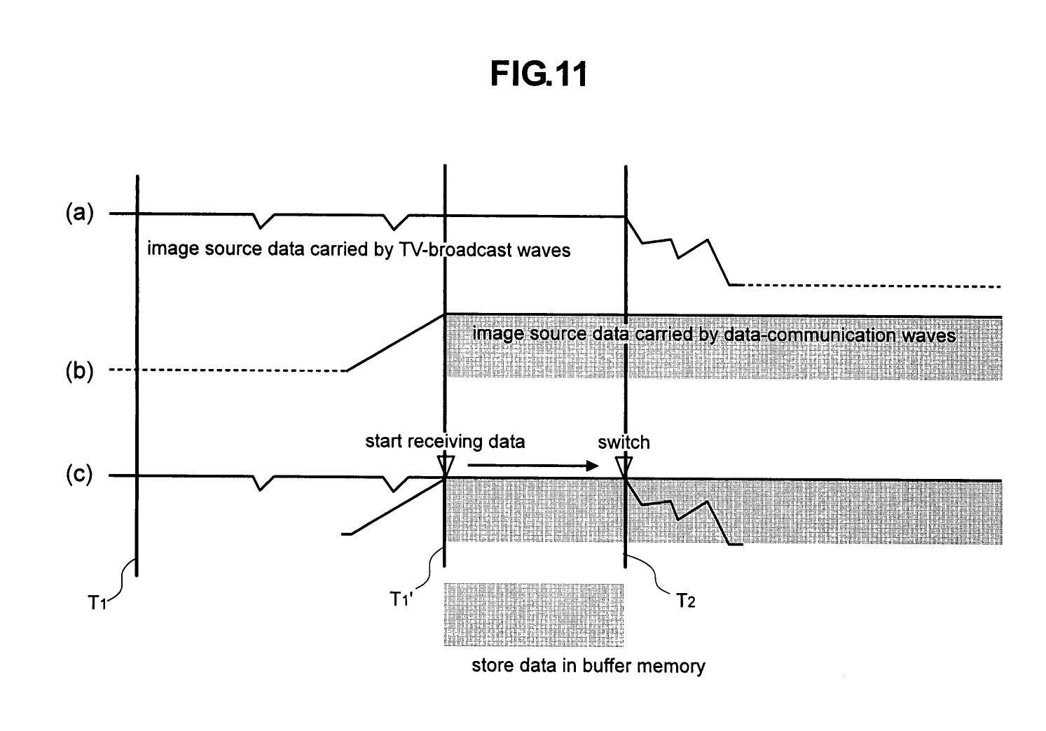

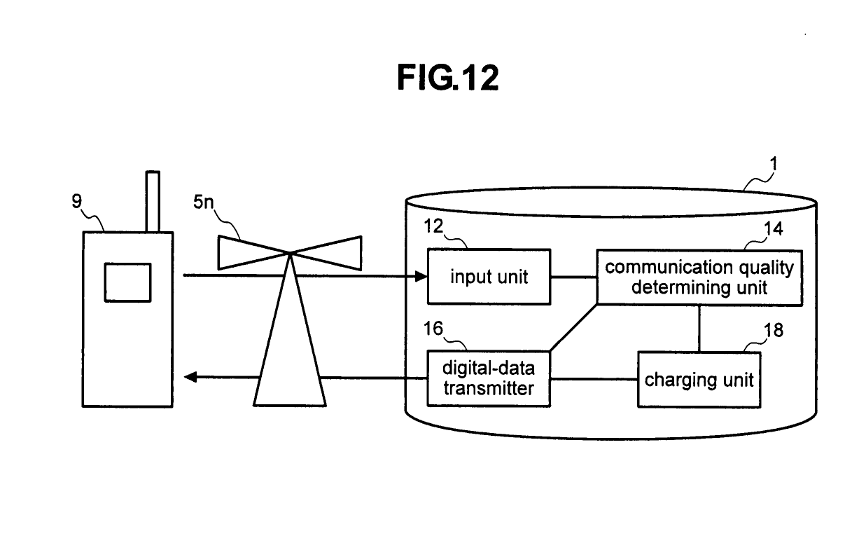

FIG. 11 is a chart showing the relationship between time and the reception sensitivity of image data carried by TV-broadcast waves received by the portable terminal 9 of FIG. 10 and the relationship between time and the reception sensitivity of image data carried by data-communication waves received by the portable terminal 9 of FIG. 10.

FIG. 11(a) shows the relationship between time and the reception sensitivity of image data carried by TV-broadcast waves described in FIGS. 7 and 8 (a). Also, FIG. 11(b) shows the relationship between time and the reception sensitivity of image data carried by data-communication waves described in FIG. 8(b). In FIG. 11(b), it is observed that the reception sensitivity of image data carried by data-communication waves is in a favorable state at time T₁′, which is considerably before time T₂ shown in FIGS. 7 and 8. FIG. 11(c) shows that the storing of image data carried by data-communication waves into the buffer memory 85 is started at time T₁.

The present invention has been described in its preferred forms and modifications. However, it is understood that they are illustrative and not restrictive and that various changes and variations may be made without departing from the sprit and scope of the invention.

1. A portable terminal, comprising:
a tuner to receive broadcast signals;
a receiver to receive data communication signals from a remote server;
a display to show images represented by image data from the broadcast signals or the data communication signals;
a detector coupled to the tuner to detect a signal intensity of the broadcast signals; and
a data processor to process the image data from the broadcast signals or the data communication signals and the send the processed image data to the display to be displayed, wherein the data processor receives and processes the image data from the broadcast signals if it is determined that the signal intensity of the broadcast signals is greater than a reference value, and receives and processes the image data from the data communication signals if it is determined that the signal intensity of the broadcast signals is less than the reference value.

2. The portable terminal of claim 1, further comprising:
a controller coupled to the detector to receive the detected signal intensity and determine whether or not the signal intensity is greater or less than the reference value.

3. The portable terminal of claim 1, further comprising:
a switch coupled to the data processor and configured to switch to a broadcast path or a data communication path according to the detected signal intensity, wherein the switch activates the broadcast path to provide the broadcast signals to the data processor if the signal intensity is determined to be greater than the reference value and activates the data communication path to provide the data communication signals if the signal intensity is determined to be less than the reference value.

4. The portable terminal of claim 3, wherein the determination of the signal intensity is performed by a controller.

5. The portable terminal of claim 1, wherein the portable terminal is a hand-held device.

6. The portable terminal of claim 5, wherein the portable terminal provides telephone features.

7. The portable terminal of claim 1, wherein the broadcast signals are television broadcast signals relating a given program and the data communication signals are signals relating to the same program.

8. The portable terminal according to claim 1, further comprising:
a module to sample the data communication signals received by the receiver of the portable terminal, wherein the sampled signals are used to determine a data rate of the data communication signals; and
a transmitter to transmit a control signal to the remote server, the control sign being generated in response to the data rate that has been determined.

9. The portable terminal of claim 8, wherein the module includes the detector.

10. The portable terminal of claim 9, wherein the module includes a controller coupled to the detector and is configured to determine the data rate.

11. The portable terminal according to claim 1, wherein the remote server transmitting the data communication signals is configured to determine the number of portable terminals that are within first and second data distribution areas.

12. The portable terminal of claim 11, wherein the first data distribution area is determined to be a high bandwidth area based on the number of portable terminals that are determined to be within the first data distribution area and the second data distribution area is determined to be a low bandwidth area based on the number of portable terminals that are determined to be within the second data distribution area.

13. The portable terminal according to claim 1, wherein the data processor receives the broadcast signals or data communication signals according to a predefined rule.

14. The portable terminal of claim 13, wherein the predefined rule is defined based on factors including fees charged to a user of the portable terminal for the data communication signals and stability of the data communication signals received by the portable terminal.

15. A digital data-distribution server for distributing digital data to a portable terminal, the server comprising:
an input unit to receive data rate transmission information on a portable terminal, the data rate transmission information providing information on a data rate at which data can be transferred to the portable terminal;
a communication quality-determining unit to determine a data rate at which data is to be transmitted to the portable terminal based on the data rate transmission information received by the input unit; and
a digital-data transmitter to transmit digital data to the portable terminal according to the data rate determined by the communication quality-determining unit.

16. The digital data-distribution server according to claim 15, wherein said communication quality-determining unit determines whether to provide high quality image data or low quality image data to the portable terminal based on the data rate transmission information.

17. The digital data-distribution server according to claim 15, further comprising:
a charging unit to charge a user of the portable terminal a fee according to the data rate at which data have been transmitted to the portable terminal from the server.

18. A method for operating a portable terminal, the method comprising:
detecting a signal intensity of broadcast signals received by the portable terminal;
receiving the broadcast signals from a first remote server;
displaying the received broadcast signals as an image on a display of the portable terminal if the signal intensity is greater than a given value;
receiving data communication signals from a second remote server; and
displaying the received data communication signals as an image on the display of the portable terminal if the signal intensity of the broadcast signals is not greater than the given value.

19. The method of claim 18, wherein the first and second remote servers are the same.

20. The method of claim 19, wherein the first and second remote servers are different.
